(19) United States
(12) Patent Application Publication
(10) Pub. No.: US 2025/0334987 A1
(43) Pub. Date: Oct. 30, 2025

(54) POWER CONTROL DEVICE

(71) Applicant: ROHM Co., Ltd., Kyoto (JP)

(72) Inventor: Kunimasa Tanaka, Kyoto (JP)

(73) Assignee: ROHM Co., Ltd., Kyoto (JP)

(21) Appl. No.: 19/096,674

(22) Filed: Mar. 31, 2025

(30) Foreign Application Priority Data
Apr. 30, 2024 (JP) 2024-073462

(51) Int. Cl. G05F 1/575; G05F 1/577; G05F 1/59

(52) U.S. Cl. CPC G05F 1/575; G05F 1/577; G05F 1/59

(57) ABSTRACT

A power control device is provided, in which an output stage circuit includes an output transistor provided between an input terminal and a switch terminal, and a rectifier element provided between the switch terminal and ground. When the output stage circuit, an output coil, and an output capacitor are provided, a control drive circuit generates an output voltage by switching drive corresponding to a feedback voltage. The feedback voltage is applied to a feedback terminal. A controller controls whether to have the control drive circuit perform switching drive based on voltages of the switch terminal and the feedback terminal at a determination timing when the switching drive is not executed.

### CROSS-REFERENCE TO RELATED APPLICATION

This application claims the priority benefits of Japanese application no. 2024-073462, filed on Apr. 30, 2024. The entirety of the above-mentioned patent application is hereby incorporated by reference herein and made a part of this specification.

### BACKGROUND

### Technical Field

The disclosure relates to a power control device.

### Description of Related Art

Power control devices are widely used as devices for controlling the operation of power supply devices (see Patent Document 1 (International Publication No. 2021/054027)). The operation of generating an output voltage from an input voltage is controlled using a power control device. In a switching regulator (switching type power supply device), an output voltage is generated from an input voltage through switching drive of an output stage circuit. There are many systems that require output voltages for a plurality of channels.

Depending on the system in which a power control device is incorporated, there are cases where an output voltage of a certain channel is required, and cases where it is not required. It is necessary to properly respond to these cases.

### SUMMARY

A power control device according to one aspect of the disclosure includes: an input terminal; a switch terminal; an output stage circuit, including an output transistor provided between the input terminal and the switch terminal, and a rectifier element provided between the switch terminal and ground; a control drive circuit, in a case where an input voltage is supplied to the input terminal, an output coil is provided between the switch terminal and an output node, and an output capacitor is provided between the output node and ground, configured to be capable of executing switching drive of the output stage circuit corresponding to a feedback voltage and to generate an output voltage based on the input voltage at the output node by the switching drive; a feedback terminal, in a case where the input voltage is supplied to the input terminal, the output coil is provided between the switch terminal and the output node, and the output capacitor is provided between the output node and ground, configured to receive the feedback voltage corresponding to the output voltage; and a controller, configured to control whether or not to have the control drive circuit perform the switching drive based on voltages of the switch terminal and the feedback terminal at a determination timing when the switching drive is not executed.

### BRIEF DESCRIPTION OF THE DRAWINGS

FIG. 1 is a schematic configuration block diagram of a power supply device according to an embodiment of the disclosure.

FIG. 2 is a perspective view showing the appearance of a power control device according to an embodiment of the disclosure.

FIG. 3 is a diagram showing how a plurality of channels of regulators are provided in a power supply device according to an embodiment of the disclosure.

FIG. 4 is a diagram showing how a plurality of channels of regulators are provided in a power supply device according to an embodiment of the disclosure.

FIG. 5 is a configuration diagram of a control block related to two channels according to an embodiment of the disclosure.

FIG. 6 is a diagram showing an internal configuration example of a discharge circuit according to an embodiment of the disclosure.

FIG. 7 is a diagram showing an internal configuration example of a voltage monitoring circuit according to an embodiment of the disclosure.

FIG. 8 is a partial configuration diagram of a power supply device according to a first example belonging to an embodiment of the disclosure.

FIG. 9 is a timing chart at startup of a regulator in a first channel according to a first example belonging to an embodiment of the disclosure.

FIG. 10 is a partial configuration diagram of a power supply device according to a second example belonging to an embodiment of the disclosure.

FIG. 11 is a timing chart related to a first channel according to a second example belonging to an embodiment of the disclosure.

FIG. 12 is a partial configuration diagram of a power supply device according to a fifth example belonging to an embodiment of the disclosure.

FIG. 13 is a timing chart related to a first channel according to a fifth example belonging to an embodiment of the disclosure.

### DESCRIPTION OF THE EMBODIMENTS

### Detailed Description

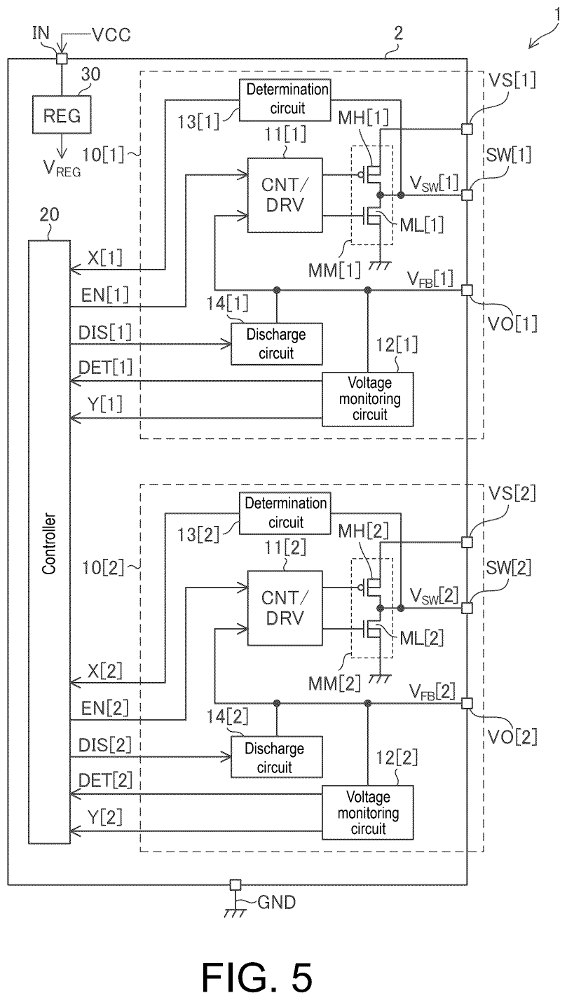

Details of examples of the embodiments of the present disclosure are given with the accompanying drawings below. In the drawings for reference, the same parts are denoted by the same numerals or symbols, and repeated description related to the same parts is in principle omitted. Moreover, in the present application, in order to keep the description simple, by means of indications in numerals or symbols to represent information, signals, physical quantities, functional units, circuits, elements or parts, names of the information, signals, physical quantities, functional units, circuits, elements or parts corresponding to the numerals or symbols are sometimes omitted or abbreviated. For example, the enable signal referred to as “EN[1]” (see FIG. 5) may be expressed as enable signal EN[1], or may be abbreviated as signal EN[1], but all of these refer to the same thing.

Some terms used in the description of the embodiments of the present disclosure are first explained below. The term “ground” refers to a reference conductive unit acting as a reference voltage of 0 V potential or the 0 V potential itself. The reference conductive unit may be a conductor formed of such as metal. The 0 V potential is sometimes referred to as ground potential. In the embodiments of the present disclosure, a voltage expressed without a specifically set reference represents a potential with respect to ground. For any concerned signal or voltage, a level refers to the level of a potential, and a high level has a potential higher than that of a low level.

For any transistor configured as a field-effect transistor (FET) such a metal-oxide-semiconductor field-effect transistor (MOSFET), an on state refers to a state of conduction between the drain and the source of the transistor, and an off state refers to a state of non-conduction (a state of disconnection) between the drain and the source of the transistor. The same applies to those categorized as non-FET transistors. Unless otherwise specified, a MOSFET is considered an enhanced MOSFET. The term MOSFET is an abbreviation of metal-oxide-semiconductor field-effect transistor. Moreover, unless otherwise specified, in any MOSFET, it is considered that the back gate is shorted with the source. In the description below, for any transistor, the on state and the off state may also be expressed simply as on and off.

Connections among a plurality of parts forming a circuit, such as arbitrary circuit elements, wirings, and nodes, may be understood to refer to electrical connections, unless otherwise specified.

In the case where any two voltages to be compared are voltage v1 and voltage v2, “v1>v2” indicates that voltage v1 is higher than voltage v2, “v1<v2” indicates that voltage v1 is lower than voltage v2, and “v1=v2” indicates that the value of voltage v1 is the same as the value of voltage v2. The same also applies to other equations that include physical quantities other than a voltage.

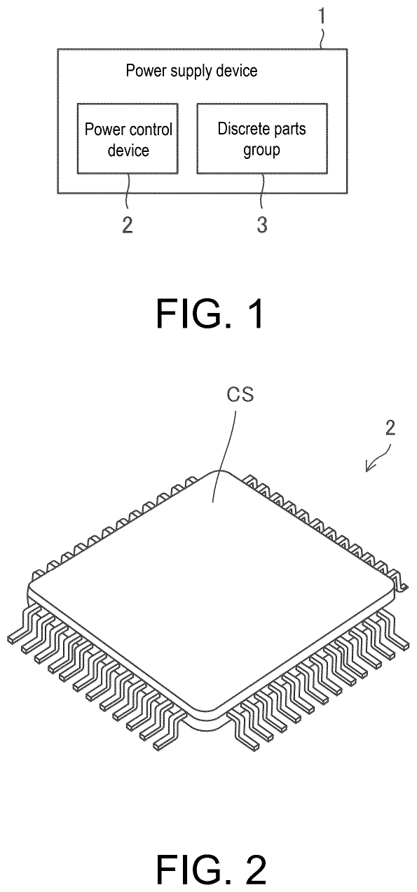

FIG. 1 is a schematic configuration block diagram of a power supply device 1 according to an embodiment of the disclosure. The power supply device 1 includes a power control device 2 and a discrete parts group 3 consisting of a plurality of discrete parts externally connected to the power control device 2. The power control device 2 may be an electronic component classified as a PMIC (power management IC). It is noted that wiring provided inside the power control device 2 may be specifically called internal wiring, and wiring provided outside the power control device 2 may be specifically called external wiring.

FIG. 2 shows a perspective view of the power control device 2. The power control device 2 is an electronic component including a semiconductor chip having a semiconductor integrated circuit formed on a semiconductor substrate, a casing CS (package) accommodating the semiconductor chip, and a plurality of external terminals exposed from the casing CS to the outside of the power control device 2. The power control device 2 is formed by sealing the semiconductor chip in the casing CS composed of resin. It is noted that the number of external terminals of the power control device 2 and the type of casing CS of the power control device 2 shown in FIG. 2 are merely exemplary, and they may be designed arbitrarily.

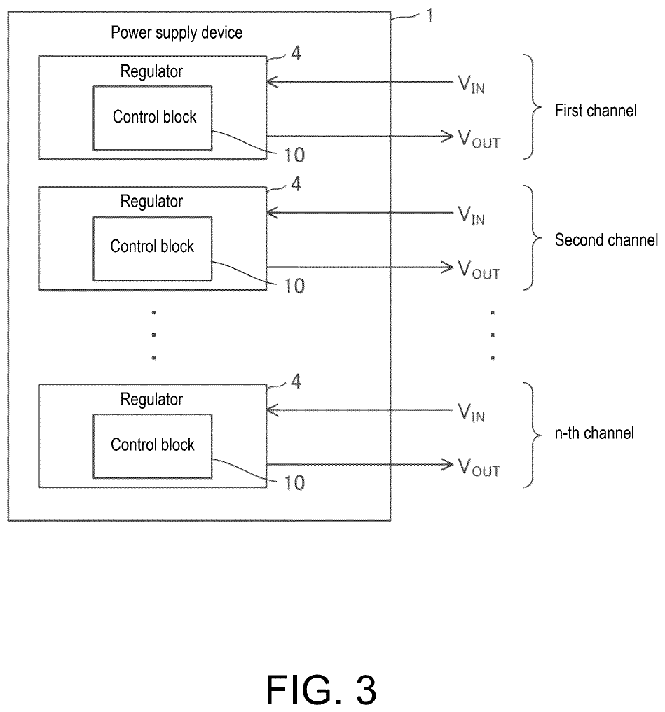

Referring to FIG. 3, the power supply device 1 is provided with regulators 4 for a maximum of n channels, that is, a maximum of n regulators 4 are provided. n represents any integer of 2 or more. The regulators 4 for n channels may also be expressed as power supply devices for n channels, in which case the power supply device 1 may also be called a composite power supply device having power supply devices (4) for n channels. Depending on the system in which the power supply device 1 is incorporated, the number of channels of regulators 4 that are provided and actually operate in the power supply device 1 may be less than n. However, here, the configuration and operation of the power supply device 1 are first be described for the case where the number of channels of regulators 4 is n.

Each regulator 4 is provided with a control block 10. The n channels consist of the first to n-th channels. Each regulator 4 receives an input voltage V_{IN} and generates an output voltage V_{OUT} by power conversion of the input voltage V_{IN}. In each channel, the input voltage V_{IN} and the output voltage V_{OUT} are different direct current voltages from each other. The input voltage V_{IN} or the output voltage V_{OUT} in each channel may be a negative direct current voltage, but in the following, the input voltage V_{IN} and the output voltage V_{OUT} in each channel are assumed to be positive direct current voltages.

One or more channels of regulators 4 in the first to n-th channels may be switching regulators. The regulator 4 as a switching regulator may be a step-down switching regulator that generates an output voltage V_{OUT} lower than the input voltage V_{IN} by stepping down the input voltage V_{IN}, or a step-up switching regulator that generates an output voltage V_{OUT} higher than the input voltage V_{IN} by stepping up the input voltage V_{IN}. All of the total n regulators 4 in the first to n-th channels may be switching regulators, or among the total n regulators 4 in the first to n-th channels, one or more switching regulators and one or more linear regulators may coexist. However, in this embodiment, it is assumed that one or more regulators 4 among the regulators 4 of the first to n-th channels may form step-down switching regulators.

The total n output voltages V_{OUT} in the first to n-th channels are different direct current voltages from each other. However, there may be cases where the value of the output voltage V_{OUT} in the i_{A}th channel matches the value of the output voltage V_{OUT} in the i_{B}th channel. Here, i_{A} and i_{B} represent any different natural numbers not exceeding n.

The total n input voltages V_{IN} in the first to n-th channels may be the same direct current voltage. That is, a common direct current voltage may be shared as the input voltage V_{IN} for the first to n-th channels. The input voltage V_{IN} in the i_{A}th channel may be the same as or different from the input voltage V_{IN} in the i_{B}th channel. The input voltage V_{IN} of any channel among the first to n-th channels may be the power supply voltage (the power supply voltage VCC to be described later) of the power control device 2.

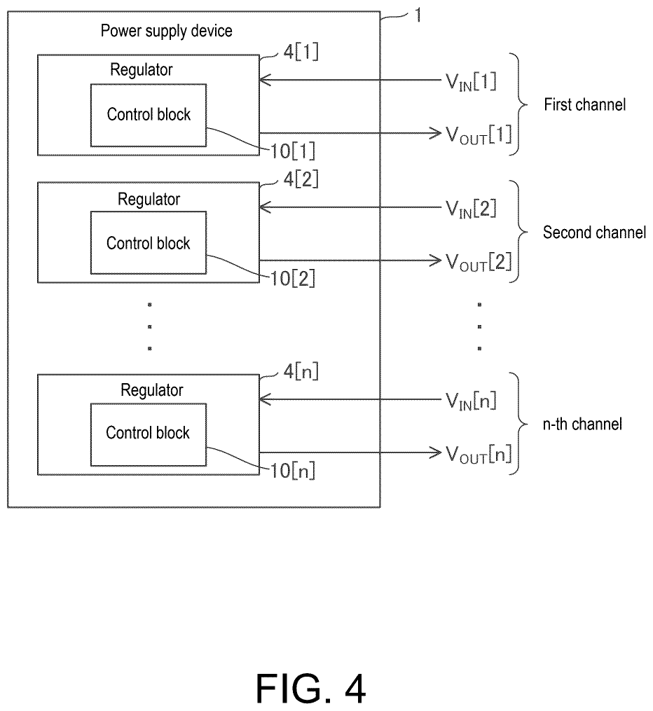

The total n control blocks 10 in the first to n-th channels are provided in the power control device 2. In each channel, the regulator 4 is formed by the control block 10 and discrete parts connected to the control block 10. As shown in FIG. 4, the regulator 4, control block 10, input voltage V_{IN}, and output voltage V_{OUT} in the i-th channel are specifically denoted as regulator 4[i], control block 10[i], input voltage V_{IN}[i], and output voltage V_{OUT}[i], respectively. i represents any integer (for example, any natural number not exceeding n).

The power supply device 1 performs an operation (power conversion) to generate the output voltage V_{OUT} from the input voltage V_{IN} for each channel. The power control device 2 controls the operation (power conversion) of the power supply device 1. That is, the power control device 2 controls the operation (power conversion) of the regulator 4 for each channel. Specifically, the operation (power conversion) of the regulator 4 in the i-th channel is controlled by the control block 10[i].

Among the regulators 4 of the first to n-th channels, the total number of step-down switching regulators may be 1, but in the following, it is assumed that the power control device 2 is configured so that the regulators 4 of the first and second channels may function as step-down switching regulators. FIG. 5 shows a partial block diagram of the power control device 2, including internal configuration diagrams of the control blocks 10[1] and 10[2], which are the control blocks 10 of the first and second channels. The power control device 2 includes a controller 20 and an internal power circuit 30 in addition to n channel control blocks 10 including the control blocks 10[1] and 10[2].

The power control device 2 is provided with a power terminal IN and a ground terminal GND as part of the plurality of external terminals. The ground terminal GND is connected to ground. A power supply voltage VCC having a positive direct current voltage value is supplied to the power terminal IN through external wiring from a voltage source (not shown) provided outside the power supply device 1. The internal power circuit 30 generates an internal power supply voltage V_{REG} based on the power supply voltage VCC. The internal power supply voltage V_{REG} has a predetermined positive direct current voltage value. Each circuit in the power control device 2 may be driven based on the internal power supply voltage V_{REG} or the power supply voltage VCC.

The control block 10 for functioning the regulator 4 as a step-down switching regulator includes an output stage circuit MM consisting of transistors MH and ML, a control drive circuit 11, a voltage monitoring circuit 12, a determination circuit 13, a discharge circuit 14, an input terminal VS, a switch terminal SW, and a feedback terminal VO. The input terminal VS, switch terminal SW, and feedback terminal VO are part of the plurality of external terminals provided in the power control device 2. The transistor MH is an output transistor and is configured with a P channel type MOSFET. The transistor ML is a synchronous rectification transistor and is configured with an N channel type MOSFET.

In the control block 10[i], the output stage circuit MM, the control drive circuit 11, the voltage monitoring circuit 12, the determination circuit 13, the discharge circuit 14, the input terminal VS, the switch terminal SW, and the feedback terminal VO are specifically referred to as the output stage circuit MM[i], the control drive circuit 11[i], the voltage monitoring circuit 12[i], the determination circuit 13[i], the discharge circuit 14[i], the input terminal VS[i], the switch terminal SW[i], and the feedback terminal VO[i], respectively. The transistors MH and ML in the output stage circuit MM are specifically referred to as transistors MH[i] and ML[i], respectively. The voltage at the switch terminal SW is represented by the symbol “V_{SW}”, and the voltage V_{SW} at the switch terminal SW[i] is specifically denoted as voltage V_{SW}[i]. The voltage at the feedback terminal VO is represented by the symbol “V_{FB}”, and the voltage V_{FB} at the feedback terminal VO[i] is specifically denoted as voltage V_{FB}[i].

The controller 20, for each channel, outputs an enable signal EN to the control drive circuit 11, outputs a discharge instruction signal DIS to the discharge circuit 14, receives a monitoring result signal DET output from the voltage monitoring circuit 12, and receives a determination signal X output from the determination circuit 13. In the i-th channel, the enable signal EN, the discharge instruction signal DIS, the monitoring result signal DET, and the determination signal X are specifically referred to as the enable signal EN[i], the discharge instruction signal DIS [i], the monitoring result signal DET[i], and the determination signal X[i], respectively. Each voltage monitoring circuit 12 outputs a determination signal Y to the controller 20 separately from the monitoring result signal DET. The determination signal Y in the i-th channel is specifically referred to as determination signal Y[i].

The source of transistor MH[1] is connected to the input terminal VS[1]. The drains of transistors MH[1] and ML[1] are commonly connected to the switch terminal SW[1]. The source of transistor ML[1] is connected to ground. The control drive circuit 11[1] is connected to the gates of transistors MH[1] and ML[1] as well as to the feedback terminal VO[1]. The voltage monitoring circuit 12[1] and discharge circuit 14[1] are also connected to the feedback terminal VO[1]. The determination circuit 13[1] is connected to the switch terminal SW[1].

When a plurality of control blocks 10 for functioning the regulator 4 as a step-down switching regulator are provided in the power control device 2, the internal configurations of these a plurality of control blocks 10 are the same as each other. Thus, the internal configuration of the control block 10[1] and the internal configuration of the control block 10[2] are the same as each other. Hence, the source of the transistor MH[2] is connected to the input terminal VS[2]. The drains of transistors MH[2] and ML[2] are commonly connected to the switch terminal SW[2]. The source of transistor ML[2] is connected to ground. The control drive circuit 11[2] is connected to the gates of transistors MH[2] and ML[2] as well as to the feedback terminal VO[2]. The voltage monitoring circuit 12[2] and discharge circuit 14[2] are also connected to the feedback terminal VO[2]. The determination circuit 13[2] is connected to the switch terminal SW[2].

In the i-th channel, the voltage monitoring circuit 12[i] may perform a voltage monitoring operation to monitor whether the voltage V_{FB}[i] falls within a predetermined normal voltage range, and when performing the voltage monitoring operation, outputs a monitoring result signal DET[i] indicating the monitoring result to the controller 20. Further, in the i-th channel, the voltage monitoring circuit 12[i] generates a determination signal Y[i] and outputs the same to the controller 20, and the determination circuit 13[i] generates a determination signal X[i] and outputs the same to the controller 20. The determination signals X[i] and Y[i] are used for determining whether to perform switching drive in the i-th channel (details are described later).

In the i-th channel, according to the discharge instruction signal DIS [i], the discharge circuit 14[i] may execute a discharge operation to discharge accumulated charge between the feedback terminal VO[i] and ground. The enable signal EN[i] is a signal that instructs the execution or prohibition of switching drive by the control drive circuit 11[i]. The signals EN[i], DIS [i], X[i], and Y[i] are binary signals having values of “0” or “1”. The monitoring result signal DET[i] may be a binary signal having values of “0” or “1”, or may have a digital value of 2 bits or more.

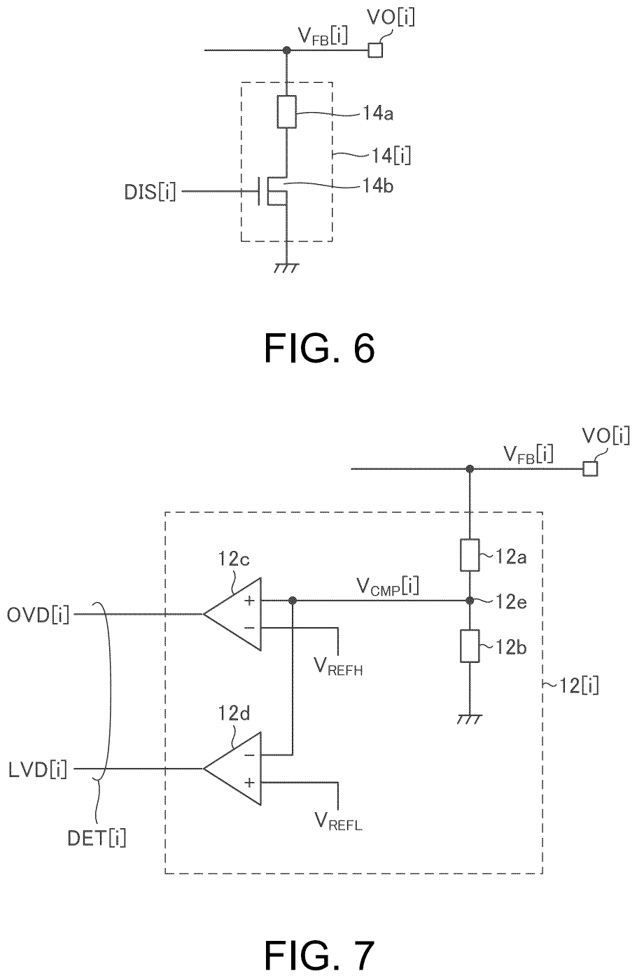

FIG. 6 shows an internal configuration example of the discharge circuit 14[i]. The discharge circuit 14[i] in FIG. 6 includes a series circuit of a resistor 14a and a transistor 14b. The transistor 14b is an N channel type MOSFET. In the discharge circuit 14[i], a first end of the resistor 14a is connected to the feedback terminal VO[i], a second end of the resistor 14a is connected to the drain of the transistor 14b, the source of the transistor 14b is connected to ground, and the discharge instruction signal DIS [i] is input to the gate of the transistor 14b. The discharge instruction signal DIS [i] has a low level or a high level, with the high level corresponding to “1” and the low level corresponding to “0” in the discharge instruction signal DIS [i]. The high level voltage in the discharge instruction signal DIS [i] is higher than the gate threshold value voltage of the transistor 14b. Thus, when the discharge instruction signal DIS [i] has a value of “1”, the transistor 14b turns on and the discharge operation is executed (i.e., the accumulated charge between the feedback terminal VO[i] and ground is discharged). The low level voltage in the discharge instruction signal DIS [i] matches the potential of ground. Thus, when the discharge instruction signal DIS [i] has a value of “0”, the transistor 14b turns off and the discharge operation is not executed.

FIG. 7 shows an example of a circuit that generates the monitoring result signal DET[i] within the internal configuration of the voltage monitoring circuit 12[i]. The voltage monitoring circuit 12[i] in FIG. 7 includes resistors 12a and 12b as well as comparators 12c and 12d. In the voltage monitoring circuit 12[i], a first end of the resistor 12a is connected to the feedback terminal VO[i], a second end of the resistor 12a is connected to a first end of the resistor 12b at a node 12e, and a second end of the resistor 12b is connected to ground. A voltage divider of the voltage V_{FB}[i] is applied to the node 12e. The voltage at the node 12e in the voltage monitoring circuit 12[i] is represented by the symbol “V_{CMP}[i]”. In each of the first and second channels in the power supply device 1 of FIG. 5, the voltage V_{CMP}[i] may be input to the control drive circuit 11[i] as feedback information of the output voltage V_{OUT}[i]. It is noted that the voltage divider circuit consisting of resistors 12a and 12b may be understood as a circuit provided separately from the voltage monitoring circuit 12[i].

The voltage V_{CMP}[i] at the node 12e is input to the non-inverting input terminal of the comparator 12c and the inverting input terminal of the comparator 12d. A reference voltage V_{REFH} is input to the inverting input terminal of the comparator 12c, and a reference voltage V_{REFL} is input to the non-inverting input terminal of the comparator 12d. The reference voltages V_{REFH} and V_{REFL} have positive direct current voltage values that satisfy “V_{REFH}>V_{REFL}”. In the voltage monitoring circuit 12[i], the comparator 12c outputs a signal OVD[i] indicating the high-low relationship between voltages V_{CMP}[i] and V_{REFH}, specifically outputting a high level signal OVD[i] in response to “V_{CMP}[i]>V_{REFH}” being satisfied, while outputting a low level signal OVD[i] in response to “V_{CMP}[i]≤V_{REFH}” being satisfied. In practice, hysteresis characteristics may be applied to the output of the comparator 12c. In the voltage monitoring circuit 12[i], the comparator 12d outputs a signal LVD[i] indicating the high-low relationship between voltages V_{CMP}[i] and V_{REFL}, specifically outputting a high level signal LVD[i] in response to “V_{CMP}[i]<V_{REFL}” being satisfied, while outputting a low level signal LVD[i] in response to “V_{CMP}[i]≥V_{REFL}” being satisfied. In practice, hysteresis characteristics may be applied to the output of the comparator 12d.

The voltage monitoring operation by the voltage monitoring circuit 12[i] is an operation that generates and outputs signals OVD[i] and LVD[i] as described above. The monitoring result signal DET[i] includes signals OVD[i] and LVD[i].

As described above, the voltage monitoring circuit 12[i] monitors in the voltage monitoring operation whether the voltage V_{FB}[i] falls within a predetermined normal voltage range. The monitoring result signal DET[i] when both signals OVD[i] and LVD[i] have low levels indicates that the voltage V_{FB}[i] falls within the predetermined normal voltage range. When signal OVD[i] or LVD[i] has a high level, the monitoring result signal DET[i] indicates that the voltage V_{FB}[i] deviates from the normal voltage range. Specifically, a high level signal OVD[i] indicates that the voltage V_{FB}[i] exceeds the upper limit of the normal voltage range, and a high level signal LVD[i] indicates that the voltage V_{FB}[i] falls below the lower limit of the normal voltage range.

In the following, among a plurality of examples, several specific operation examples, application technologies, modification technologies, etc. related to the power supply device 1 are described. The items described in the embodiment are applied to the following examples unless otherwise stated, as long as there is no contradiction. The description in the examples may be prioritized when there are items in the examples inconsistent with the items described above. The items described in any example among the plurality of examples illustrated below can also be applied to any other examples (that is, any two or more examples among the plurality of examples can be combined).

### First Example

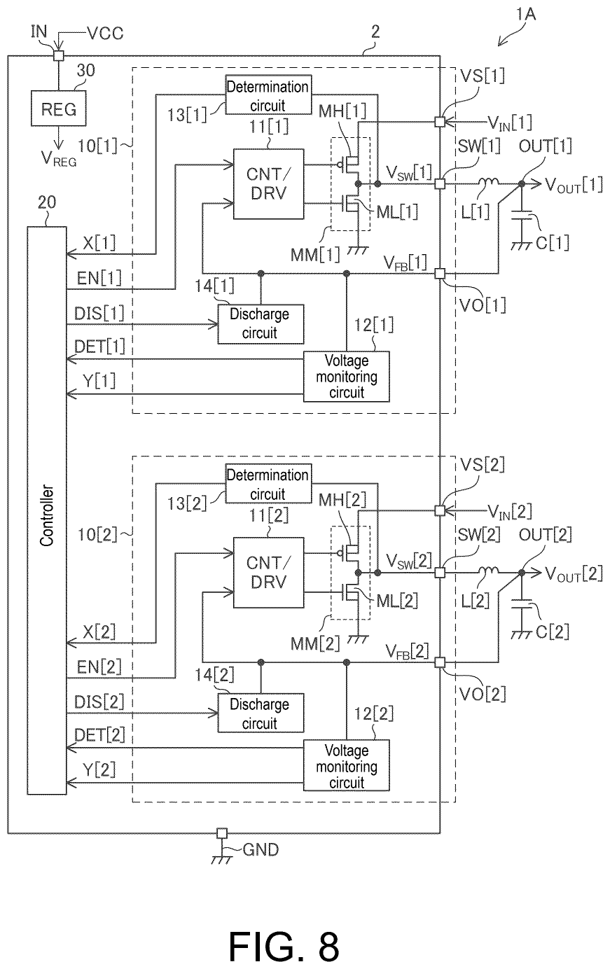

The first example will be described. FIG. 8 shows a partial configuration diagram of a power supply device 1A, which is a power supply device 1 according to the first example. In the power supply device 1A, the regulators 4 of the first and second channels actually function as step-down switching regulators. In the case where “n≥3”, the regulator 4 of the i-th channel satisfying “3≤i≤n” may be any of a step-down switching regulator, a step-up switching regulator, and a linear regulator.

The configuration and operation of the regulator 4 of the first channel in the power supply device 1A will be described. In the power supply device 1A, an output coil L[1] and an output capacitor C[1] are provided as components of the regulator 4 of the first channel. In the power supply device 1A, a step-down switching regulator is formed by the output stage circuit MM[1], the control drive circuit 11[1], the output coil L[1], and the output capacitor C[1]. The output coil L[1] and the output capacitor C[1] are components of the discrete parts group 3 (refer to FIG. 1).

From a voltage source (not shown) provided outside the power supply device 1A, an input voltage V_{IN}[1] having a positive direct current voltage value is supplied to the input terminal VS[1] through external wiring. In the power supply device 1A, the source of the transistor MH[1] is connected to the input terminal VS[1] and receives the input voltage V_{IN}[1]. The drains of transistors MH[1] and ML[1] are commonly connected to the switch terminal SW[1]. In the power supply device 1A, the switch terminal SW[1] is connected to the first end of the output coil L[1], and the second end of the output coil L[1] is connected to the output node OUT[1]. The source of transistor ML[1] is connected to ground. In the power supply device 1A, an output capacitor C[1] is provided between the output node OUT[1] and ground. That is, the first end of the output capacitor C[1] is connected to the output node OUT[1], and the second end of the output capacitor C[1] is connected to ground. In the power supply device 1A, an output voltage V_{OUT}[1] is generated at the output node OUT[1].

In the power supply device 1A, feedback information of the output voltage V_{OUT}[1] is input to the control drive circuit 11[1]. In FIG. 8, the feedback terminal VO[1] is connected to the output node OUT[1] through external wiring and connected to the control drive circuit 11[1] through internal wiring (that is, the output node OUT[1] is connected to the control drive circuit 11[1] via the feedback terminal VO[1]), so that the output voltage V_{OUT}[1] itself is input to the control drive circuit 11[1] as feedback information of the output voltage V_{OUT}[1]. However, the feedback information of the output voltage V_{OUT}[1] may be a voltage division of the output voltage V_{OUT}[1].

The control drive circuit 11[1] is connected to each gate of transistors MH[1] and ML[1]. In the power supply device 1A, the control drive circuit 11[1] individually controls the transistors MH[1] and ML[1] to be on or off by controlling each gate potential of the transistors MH[1] and ML[1]. The control drive circuit 11[1] in the power supply device 1A performs switching drive (switching control) to alternately turn the transistors MH[1] and ML[1] on and off based on the feedback information of the output voltage V_{OUT}[1], so that the output voltage V_{OUT}[1] is stabilized at a predetermined target voltage V_{TG}[1]. Due to this switching drive, a rectangular wave voltage (a rectangular wave voltage that fluctuates approximately between 0V and the input voltage V_{IN}[1]) is generated at the switch terminal SW[1], which is the connection node between the transistors MH[1] and ML[1]. The output voltage V_{OUT}[1] is generated at the output node OUT[1] as this rectangular wave voltage is rectified and smoothed by the output coil L[1] and the output capacitor C[1]. It is noted that a modification in which the transistor MH[1] is configured with an N channel type MOSFET may also be adopted, and in this case, it is sufficient to add a well-known boost circuit to generate a boosted voltage higher than the input voltage V_{IN}[1] and use the boosted voltage to achieve the on state of the transistor MH[1].

The configuration and operation of the regulator 4 of the second channel in the power supply device 1A will be described. In the power supply device 1A, an output coil L[2] and an output capacitor C[2] are provided as components of the regulator 4 of the second channel. In the power supply device 1A, a step-down switching regulator is formed by the output stage circuit MM[2], the control drive circuit 11[2], the output coil L[2], and the output capacitor C[2]. The output coil L[2] and the output capacitor C[2] are components of the discrete parts group 3 (refer to FIG. 1). In the power supply device 1A, the configuration and operation of the regulator 4 of the second channel are similar to the configuration and operation of the regulator 4 of the first channel.

In other words, an input voltage V_{IN}[2] having a positive direct current voltage value is supplied from a voltage source (not shown) provided outside the power supply device 1A to the input terminal VS[2] through external wiring. In the power supply device 1A, the source of the transistor MH[2] is connected to the input terminal VS[2] and receives the input voltage V_{IN}[2]. The drains of transistors MH[2] and ML[2] are commonly connected to the switch terminal SW[2]. In the power supply device 1A, the switch terminal SW[2] is connected to the first end of the output coil L[2], and the second end of the output coil L[2] is connected to the output node OUT[2]. The source of transistor ML[2] is connected to ground. In the power supply device 1A, the output capacitor C[2] is provided between the output node OUT[2] and ground. That is, the first end of the output capacitor C[2] is connected to the output node OUT[2], and the second end of the output capacitor C[2] is connected to ground. In the power supply device 1A, the output voltage V_{OUT}[2] is generated at the output node OUT[2].

In the power supply device 1A, feedback information of the output voltage V_{OUT}[2] is input to the control drive circuit 11[2]. In FIG. 8, the feedback terminal VO[2] is connected to the output node OUT[2] through external wiring and connected to the control drive circuit 11[2] through internal wiring (that is, the output node OUT[2] is connected to the control drive circuit 11[2] via the feedback terminal VO[2]), so that the output voltage V_{OUT}[2] itself is input to the control drive circuit 11[2] as feedback information of the output voltage V_{OUT}[2]. However, the feedback information of the output voltage V_{OUT}[2] may be a voltage division of the output voltage V_{OUT}[2].

The control drive circuit 11[2] is connected to each gate of transistors MH[2] and ML[2]. In the power supply device 1A, the control drive circuit 11[2] individually controls the transistors MH[2] and ML[2] to be on or off by controlling each gate potential of the transistors MH[2] and ML[2]. The control drive circuit 11[2] in the power supply device 1A performs switching drive (switching control) to alternately turn the transistors MH[2] and ML[2] on and off based on the feedback information of the output voltage V_{OUT}[2], so that the output voltage V_{OUT}[2] is stabilized at a predetermined target voltage V_{TG}[2]. Due to this switching drive, a rectangular wave voltage (a rectangular wave voltage that fluctuates approximately between 0V and the input voltage V_{IN}[2]) is generated at the switch terminal SW[2], which is the connection node between the transistors MH[2] and ML[2]. The output voltage V_{OUT}[2] is generated at the output node OUT[2] as this rectangular wave voltage is rectified and smoothed by the output coil L[2] and the output capacitor C[2]. It is noted that a modification in which the transistor MH[2] is configured with an N channel type MOSFET may also be adopted, and in this case, it is sufficient to add a well-known boost circuit to generate a boosted voltage higher than the input voltage V_{IN}[2] and use the boosted voltage to achieve the on state of the transistor MH[2].

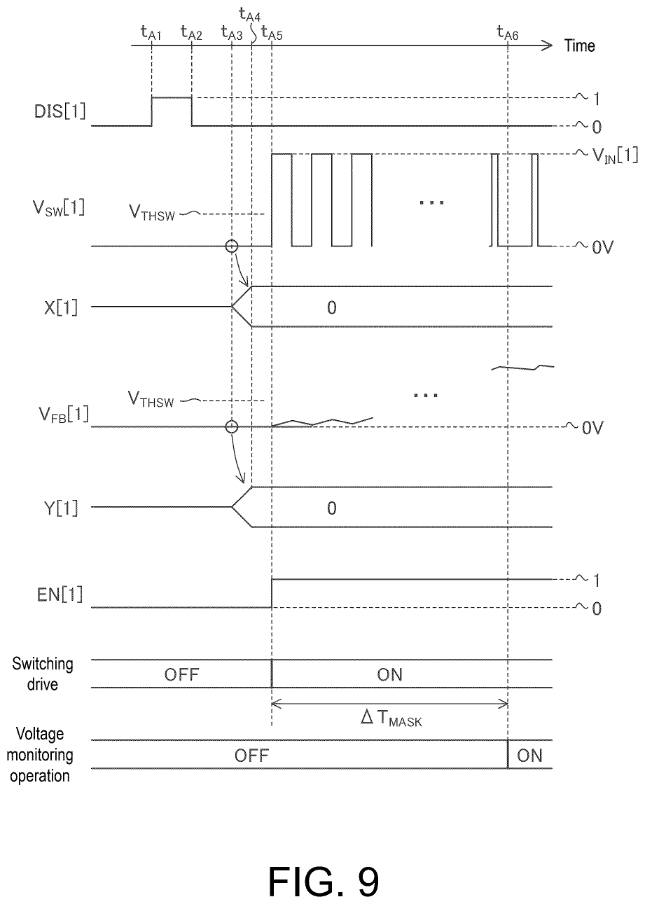

FIG. 9 shows a timing chart at startup of the regulator 4 in the first channel of the power supply device 1A. With the progression of time, times t_{A1}, t_{A2}, t_{A3}, t_{A4}, t_{A5}, and t_{A6} arrive in this order. After a predetermined initial sequence operation is executed in the controller 20 as the controller 20 starts up in response to the start of power supply voltage VCC supply to the power terminal IN, time t_{A1} is reached.

Immediately before time t_{A1}, since the discharge instruction signal DIS [1] has a value of “0”, the discharge operation is not executed in the discharge circuit 14[1]. However, the discharge operation may be executed by the discharge circuit 14[1] before time t_{A1}. Further, immediately before time t_{A1}, the enable signal EN[1] has a value of “0”. The enable signal EN[1] with a value of “0” is a signal that instructs the control drive circuit 11[1] to prohibit the execution of switching drive, and when the enable signal EN[1] has a value of “0”, the control drive circuit 11[1] stops the switching drive. When the switching drive is stopped in the control drive circuit 11[1], the control drive circuit 11[1] maintains both transistors MH[1] and ML[1] in the off state. In FIG. 9, it is assumed that before reaching time t_{A1}, for a sufficiently long time, the switching drive by the control drive circuit 11[1] is stopped and due to the influence of the resistor component connected to the output node OUT[1], the voltage of the output node OUT[1] has decreased to substantially 0V. Thus, immediately before time t_{A1}, voltages V_{SW}[1] and V_{FB}[1] are substantially 0V. It is noted that the determination signals X[1] and Y[1] do not have significant values until time t_{A4}, which will be described later.

The controller 20 executes the discharge operation in the discharge circuit 14[1] by setting the discharge instruction signal DIS [1] to a value of “1” for a predetermined discharge time from time t_{A1}, and stops the discharge operation by the discharge circuit 14[1] by returning the value of the discharge instruction signal DIS [1] to “0” at time t_{A2} when the discharge time has elapsed from time t_{A1}. Thus, even if charge is accumulated in the output capacitor C[1] at time t_{A1}, at time t_{A2}, voltages V_{SW}[1] and V_{FB}[1] decrease to substantially 0V.

At time t_{A3}, which is a short time after time t_{A2}, the determination circuit 13[1] compares voltage V_{SW}[1] with threshold voltage V_{THSW} and generates a determination signal X[1] indicating their high-low relationship, while the voltage monitoring circuit 12[1] compares voltage V_{FB}[1] with threshold voltage V_{THFB} and generates a determination signal Y[1] indicating their high-low relationship. The threshold voltages V_{THSW} and V_{THEB} each have predetermined positive voltage values. The threshold voltages V_{THSW} and V_{THEB} may have the same voltage value or may have different voltage values from each other. The values of determination signals X[1] and Y[1] are confirmed at time t_{A4}, which is a short time after time t_{A3}.

The determination circuit 13[1] outputs determination signal X[1] having a value of “0” at time t_{A4} and thereafter in the case of “V_{SW}[1]<V_{THSW}” being satisfied at time t_{A3}, and outputs determination signal X[1] having a value of “1” at time t_{A4} and thereafter in the case of “V_{SW}[1]≥V_{THSW}” being satisfied at time t_{A3}. The voltage monitoring circuit 12[1] outputs determination signal Y[1] having a value of “0” at time t_{A4} and thereafter in the case of “V_{FB}[1]<V_{THFB}” being satisfied at time t_{A3}, and outputs determination signal Y[1] having a value of “1” at time t_{A4} and thereafter in the case of “V_{FB}[1]≥V_{THFB}” being satisfied at time t_{A3}. In the power supply device 1A, since voltages V_{SW}[1] and V_{FB}[1] decrease to substantially 0V by time t_{A2}, “V_{SW}[1]<V_{THSW}” and “V_{FB}[1]<V_{THFB}” are satisfied at time t_{A3}. Thus, determination signals X[1] and Y[1] having a value of “0” are output at time t_{A4} and thereafter.

It is noted that the voltage monitoring circuit 12[1] may include a second circuit block that compares voltage V_{FB}[1] with threshold voltage V_{THFB} to generate determination signal X[1], separately from the first circuit block consisting of resistors 12a and 12b and comparators 12c and 12d shown in FIG. 7 (in this case, the second circuit block may be considered as a second determination circuit provided separately from the voltage monitoring circuit 12[1]). Alternatively, the voltage monitoring circuit 12[1] may generate determination signal X[1] by the first circuit block. In this case, at time t_{A3}, the voltage temporarily input to the inverting input terminal of comparator 12c should be set to a voltage corresponding to threshold voltage V_{THFB} (during the period in which voltage monitoring operation is performed, reference voltage V_{REFH} is input to the inverting input terminal of comparator 12c as a general rule). The voltage corresponding to threshold voltage V_{THFB} is determined by threshold voltage V_{THFB} and the resistance ratio between resistors 12a and 12b.

The controller 20 determines whether to have the control drive circuit 11[1] perform switching drive based on the values of determination signals X[1] and Y[1] at time t_{A4}. Only in the case where determination signals X[1] and Y[1] both have a value of “0”, the controller 20 determines to have the control drive circuit 11[1] perform switching drive, and switches the value of enable signal EN[1] from “0” to “1” at time t_{A5}, which is a short time after time t_{A4}. The enable signal EN[1] of “1” is a signal that instructs the control drive circuit 11[1] to execute switching drive, and when the enable signal EN[1] has a value of “1”, the control drive circuit 11[1] executes switching drive. Thus, after time t_{A5}, switching drive is executed by the control drive circuit 11[1]. When switching drive is performed in the control drive circuit 11[1], voltage V_{FB}[1] functions as a feedback voltage corresponding to output voltage V_{OUT}[1], and the control drive circuit 11[1] alternately switches transistors MH[1] and ML[1] on and off using pulse width modulation or the like so that output voltage V_{OUT}[1] is stabilized at target voltage V_{TG}[1] based on the feedback voltage.

Time t_{A6} is the time after a predetermined mask time ΔT_{MASK} from time t_{A5}. Until time t_{A6}, the voltage monitoring operation by the voltage monitoring circuit 12[1] is stopped, and the monitoring result signal DET[1] is invalid. After time t_{A6}, the voltage monitoring operation by the voltage monitoring circuit 12[1] operates effectively, and the monitoring result signal DET[1] becomes valid. Unless there is a particular abnormality, it is expected, based on the configuration of the power supply device 1A, that the output voltage V_{OUT}[1] will reach the target voltage V_{TG}[1] or approach the target voltage V_{TG}[1] by time t_{A6}. The mask time ΔT_{MASK} is preset based on the time required for the output voltage V_{OUT}[1] to reach the target voltage V_{TG}[1] or approach the target voltage V_{TG}[1] after switching drive is started in the first channel.

After time t_{A6}, the controller 20 determines the presence or absence of abnormality in the output voltage V_{OUT}[1] based on signals OVD[1] and LVD[1]. After time t_{A6}, in the case where signals OVD[1] and LVD[1] both have low levels, the controller 20 determines that there is no abnormality in the output voltage V_{OUT}[1]. After time t_{A6}, if there is no particular abnormality, the output voltage V_{OUT}[1] remains within the above-mentioned normal voltage range, and signals OVD[1] and LVD[1] forming the monitoring result signal DET[1] are both maintained at low levels. The target voltage V_{TG}[1] is within the normal voltage range.

After time t_{A6}, in response to the level of signal OVD[1] switching from low level to high level, the controller 20 determines that a high side abnormality has occurred in the output voltage V_{OUT}[1]. Alternatively, after time t_{A6}, in response to the level of signal OVD[1] switching from low level to high level and the state where signal OVD[1] has a high level continuing for more than a predetermined time, the controller 20 determines that a high side abnormality has occurred in the output voltage V_{OUT}[1]. Although not particularly illustrated, for example, after time t_{A6}, in the case where an abnormality (short to power) occurs in which the output node OUT[1] is shorted to the input terminal VS[1] or the power terminal IN, it is determined that a high side abnormality has occurred.

After time t_{A6}, in response to the level of signal LVD[1] switching from low level to high level, the controller 20 determines that a low side abnormality has occurred in the output voltage V_{OUT}[1]. Alternatively, after time t_{A6}, in response to the level of signal LVD[1] switching from low level to high level and the state where signal LVD[1] has a high level continuing for more than a predetermined time, the controller 20 determines that a low side abnormality has occurred in the output voltage V_{OUT}[1]. Although not particularly illustrated, for example, after time t_{A6}, in the case where an abnormality (ground fault) occurs in which the output node OUT[1] is shorted to ground, it is determined that a low side abnormality has occurred.

In response to determining that a high side abnormality or a low side abnormality has occurred in the output voltage V_{OUT}[1], the controller 20 performs a predetermined abnormal response operation. In the abnormal response operation related to the output voltage V_{OUT}[1], the controller 20 stops the switching drive by the control drive circuit 11[1] by switching the value of the enable signal EN[1] from “1” to “0”, and outputs a predetermined error signal from a power good terminal (not shown). The power good terminal is one of the external terminals of the power control device 2.

In this manner, the controller 20 controls whether to have the control drive circuit 11[1] perform switching drive afterward based on the voltage V_{SW}[1] of the switch terminal SW[1] and the voltage V_{FB}[1] of the feedback terminal VO[1] at the determination timing when the switching drive by the control drive circuit 11[1] is not executed. In the timing chart shown in FIG. 9, time t_{A3} corresponds to the determination timing. At the determination timing, since the transistors MH[1] and ML[1] are off, the current through the switch terminal SW[1] is blocked (there is no input/output of current between the output stage circuit MM[1] and the switch terminal SW[1]). Thus, in the power supply device 1A having the configuration of FIG. 8, the voltage V_{SW}[1] at the determination timing becomes lower than the threshold voltage V_{THSW}. Further, a resistor (corresponding to a series circuit of resistors 12a and 12b; refer to FIG. 7) is provided between the feedback terminal VO[1] and ground. Thus, in the power supply device 1A having the configuration of FIG. 8, the voltage V_{FB}[1] at the determination timing becomes lower than the threshold voltage V_{THFB}. In the case where the voltage V_{SW}[1] is lower than the threshold voltage V_{THSW} and the voltage V_{FB}[1] is lower than the threshold voltage V_{THEB} at the determination timing, the controller 20 has the control drive circuit 11[1] perform switching drive after the determination timing.

With reference to FIG. 9, the operation at startup of the regulator 4 in the first channel of the power supply device 1A has been described, but the operation at startup of the regulator 4 in the second channel of the power supply device 1A is similar to the operation at startup of the regulator 4 in the first channel. In the power supply device 1A, if the symbol “[1]” in the description of the first channel operation is replaced with the symbol “[2]”, the description of the first channel operation is replaced with the description of the second channel operation. However, the times t_{A1} to t_{A6} for the first channel and the times t_{A1} to t_{A6} for the second channel may be offset from each other.

### Second Example

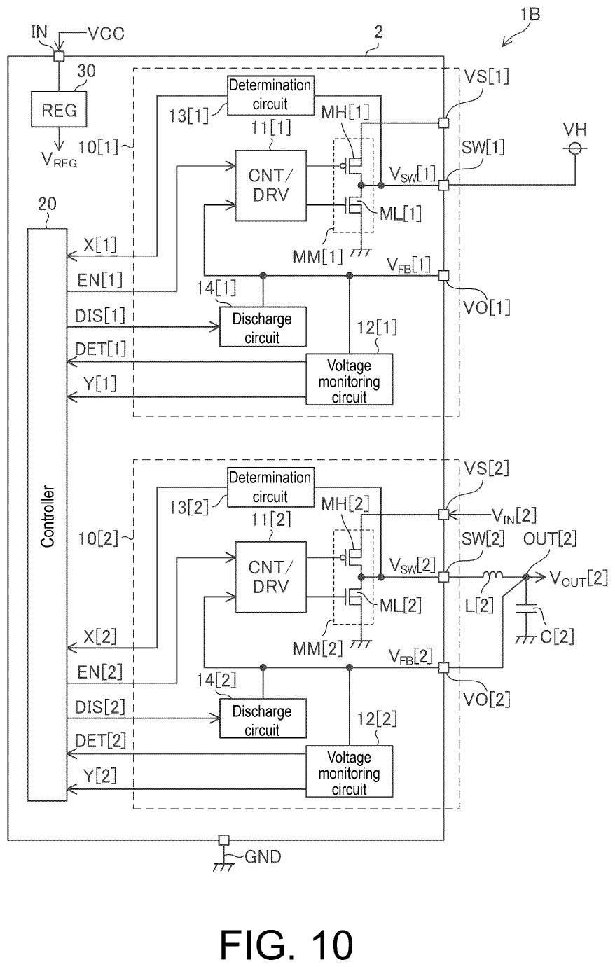

The second example will be described. FIG. 10 shows a partial configuration diagram of a power supply device 1B, which is a power supply device 1 according to the second example. In the power supply device 1B, the regulator 4 of the second channel actually functions as a step-down switching regulator. However, in the power supply device 1B, the regulator 4 of the first channel does not function as a step-down switching regulator. In the power supply device 1B, although some components of the step-down switching regulator (MM[1] and 11[1]) are provided in the power control device 2 for the first channel, the remaining components of the step-down switching regulator, namely the output coil and output capacitor (corresponding to L[1] and C[1] in FIG. 8), are not provided. That is, in the power supply device 1B, the regulator 4 of the first channel does not substantially exist. In the power supply device 1B, in the case of “n≥3”, the regulator 4 of the i-th channel satisfying “3≤i≤n” may be any of a step-down switching regulator, a step-up switching regulator, and a linear regulator.

Although the external configuration of the power control device 2 differs between the first and second examples, the power control device 2 according to the second example is the same as the power control device 2 according to the first example. Thus, regarding the operation of the power control device 2, matters not specifically mentioned in the second example are applicable to the second example as described in the first example, unless there is a specific contradiction.

In the power supply device 1B, the input terminal VS[1] is left open. However, in the power supply device 1B, a predetermined voltage may be applied to the input terminal VS[1] through external wiring. In the power supply device 1B, the feedback terminal VO[1] is left open. However, in the power supply device 1B, the feedback terminal VO[1] may be connected to ground. In the power supply device 1B, the switch terminal SW[1] is connected to a positive voltage VH application end (a terminal to which voltage VH is applied) through external wiring. The voltage VH is equal to or higher than the threshold voltage V_{THSW} mentioned above, and it is preferable that it is sufficiently higher than the threshold voltage V_{THSW}. Typically, the voltage VH may be the power supply voltage VCC. In the power supply device 1B, the feedback terminal VO[1] and the switch terminal SW[1] are not connected.

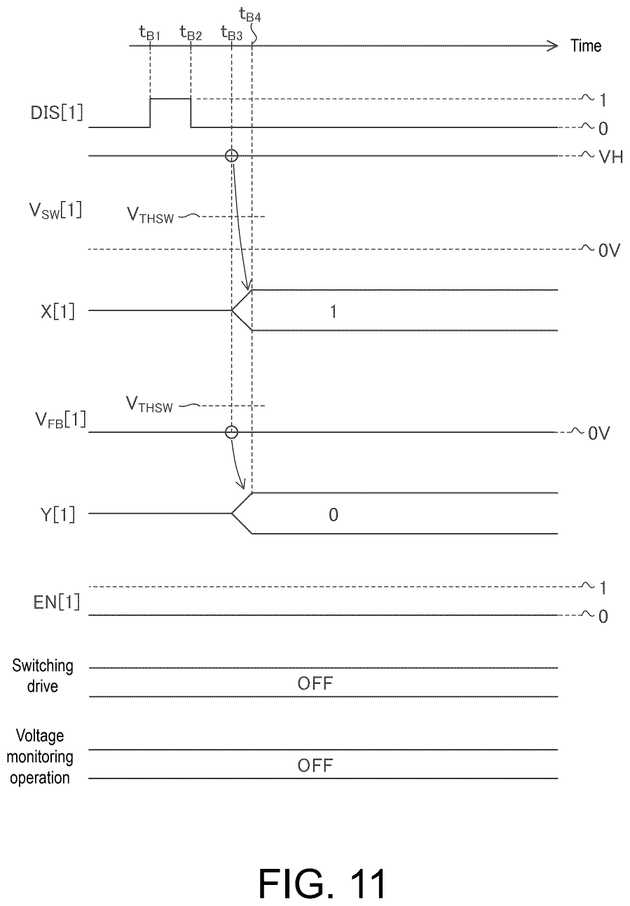

FIG. 11 shows a timing chart for the first channel of the power supply device 1B. As time progresses, times t_{B1}, t_{B2}, t_{B3}, and t_{B4} arrive in this order. After a predetermined initial sequence operation is executed in the controller 20 as the controller 20 starts up in response to the start of power supply voltage VCC supply to the power terminal IN, time t_{B1} is reached.

Immediately before time t_{B1}, since the discharge instruction signal DIS [1] has a value of “0”, the discharge operation is not executed in the discharge circuit 14[1]. Further, immediately before time t_{B1}, the enable signal EN[1] has a value of “0”. The enable signal EN[1] with a value of “0” is a signal that instructs the control drive circuit 11[1] to prohibit the execution of switching drive, and when the enable signal EN[1] has a value of “0”, the control drive circuit 11[1] stops the switching drive. When the switching drive is stopped in the control drive circuit 11[1], the control drive circuit 11[1] maintains both transistors MH[1] and ML[1] in the off state. In the power supply device 1B, since the voltage VH is constantly applied to the switch terminal SW[1], immediately before time t_{B1}, the voltage V_{SW}[1] coincides with the voltage VH, and thereafter, the voltage V_{SW}[1] continues to coincide with the voltage VH. The determination signals X[1] and Y[1] do not have significant values until time t_{B4}, which will be described later.

The controller 20 executes the discharge operation in the discharge circuit 14[1] by setting the discharge instruction signal DIS [1] to a value of “1” for a predetermined discharge time from time t_{B1}, and stops the discharge operation by the discharge circuit 14[1] by returning the value of the discharge instruction signal DIS [1] to “0” at time t_{B2} when the discharge time has elapsed from time t_{B1}. Thus, in the power supply device 1B, the voltage V_{FB}[1] at time t_{B2} becomes substantially 0V.

At time t_{B3}, which is a short time after time t_{B2}, the determination circuit 13[1] compares the voltage V_{SW}[1] with the threshold voltage V_{THSW} and generates the determination signal X[1] indicating their high-low relationship, while the voltage monitoring circuit 12[1] compares the voltage V_{FB}[1] with the threshold voltage V_{THEB} and generates the determination signal Y[1] indicating their high-low relationship. The threshold voltages V_{THSW} and V_{THEB} are as described in the first example. The values of determination signals X[1] and Y[1] are confirmed at time t_{B4}, which is a small amount of time after time t_{B3}.

The determination circuit 13[1] outputs determination signal X[1] having a value of “0” at time t_{B4} and thereafter in the case of “V_{SW}[1]<V_{THSW}” being satisfied at time t_{B3}, and outputs determination signal X[1] having a value of “1” at time t_{B4} and thereafter in the case of “V_{SW}[1]≥V_{THSW}” being satisfied at time t_{B3}. The voltage monitoring circuit 12[1] outputs determination signal Y[1] having a value of “0” at time t_{B4} and thereafter in the case of “V_{FB}[1]<V_{THEB}” being satisfied at time t_{B3}, and outputs determination signal Y[1] having a value of “1” at time t_{B4} and thereafter in the case of “V_{FB}[1]≥V_{THFB}” being satisfied at time t_{B3}. In the power supply device 1B, since the constant voltage VH is applied to the switch terminal SW[1], “V_{SW}[1]≥V_{THSW}” is satisfied at time t_{B3}. On the other hand, in the power supply device 1B, since the voltage V_{FB}[1] has decreased to substantially 0V by time t_{B2}, “V_{FB}[1]<V_{THFB}” is satisfied at time t_{B3}. Thus, a determination signal X[1] with a value of “1” and a determination signal Y[1] with a value of “0” are output at time t_{B4} and thereafter.

The controller 20 determines whether to have the control drive circuit 11[1] perform switching drive based on the values of determination signals X[1] and Y[1] at time t_{B4}. As described in the first example, the controller 20 determines to have the control drive circuit 11[1] perform switching drive only in the case where both determination signals X[1] and Y[1] have a value of “0”. In the power supply device 1B, since the determination signals X[1] and Y[1] at time t_{B4} satisfy “(X[1],Y[1])=(1,0)”, the controller 20 determines not to have the control drive circuit 11[1] perform switching drive. The case where the determination signals X[1] and Y[1] at time t_{B4} satisfy “(X[1],Y[1])=(1,0)” is hereinafter called a channel non-use case. The channel non-use case is a case where the voltage V_{SW}[1] is equal to or higher than the threshold voltage V_{THSW} and the voltage V_{FB}[1] is lower than the threshold voltage V_{THEB} at time t_{B3} corresponding to the determination timing. In the channel non-use case, the controller 20 maintains the value of the enable signal EN[1] at “0” even after time t_{B4}, and thus the transistors MH[1] and ML[1] are maintained in the off state by the control drive circuit 11[1].

In the channel non-use case, the voltage monitoring operation of the voltage monitoring circuit 12[1] is not executed, and the monitoring result signal DET[1] is invalid. Thus, in the channel non-use case, the controller 20 does not execute determination of the presence or absence of abnormality in the output voltage V_{OUT}[1] based on signals OVD[1] and LVD[1] (the output voltage V_{OUT}[1] does not exist in the first place), and does not execute abnormal response operation based on signals OVD[1] and LVD[1]. In the channel non-use case, the above-mentioned error signal based on signals OVD[1] and LVD[1] is not transmitted either.

In this manner, the controller 20 controls whether to have the control drive circuit 11[1] perform switching drive afterward based on the voltage V_{SW}[1] of the switch terminal SW[1] and the voltage V_{FB}[1] of the feedback terminal VO[1] at the determination timing when the switching drive by the control drive circuit 11[1] is not executed. In the timing chart shown in FIG. 11, time t3 corresponds to the determination timing. At the determination timing, since the transistors MH[1] and ML[1] are off, the current through the switch terminal SW[1] is blocked (there is no input/output of current between the output stage circuit MM[1] and the switch terminal SW[1]). Thus, in the power supply device 1B having the configuration of FIG. 10, the voltage V_{SW}[1] at the determination timing is equal to or higher than the threshold voltage V_{THSW}. Further, a resistor (corresponding to a series circuit of resistors 12a and 12b; refer to FIG. 7) is provided between the feedback terminal VO[1] and ground. Thus, in the power supply device 1B having the configuration of FIG. 10, the voltage V_{FB}[1] at the determination timing becomes lower than the threshold voltage V_{THFB}. A case where the voltage V_{SW}[1] is equal to or higher than the threshold voltage V_{THSW} and the voltage V_{FB}[1] is lower than the threshold voltage V_{THFB} at the determination timing is a channel non-use case.

In the channel non-use case, the controller 20 stops the switching drive by the control drive circuit 11[1] after the determination timing (controls the control drive circuit 11[1] so that transistors MH[1] and ML[1] are maintained off). In the channel non-use case, the voltage monitoring operation by the voltage monitoring circuit 12[1] is stopped (not executed). Thus, in the channel non-use case, the controller 20 stops the execution of abnormal response operation based on the voltage V_{FB}[1] of the feedback terminal VO[1] (does not execute abnormal response operation based on the voltage V_{FB}[1] regardless of the relationship between the voltage V_{FB}[1] and the normal voltage range).

The configuration and operation of the regulator 4 of the second channel in the power supply device 1B are the same as the configuration and operation of the regulator 4 of the second channel in the power supply device 1A. In the power supply device 1B, it is also possible to configure the second channel with the same configuration as the first channel, and in this case, switching drive and voltage monitoring operation in the second channel are also not executed.

Although the power control device 2 may generate output voltages V_{OUT} for up to n channels, depending on the system, there may be cases where the number of channels requiring output voltage V_{OUT} is (n−1) channels or fewer. To accommodate these cases, one method would be to manufacture power control devices for n channels and power control devices for (n−1) channels as separate electronic components, but this method leads to increased burden in product development, manufacturing, and inventory management. The same applies when separately manufacturing power control devices for (n−2) channels, etc. According to this embodiment, with a common power control device 2, it is possible to accommodate cases where the number of channels requiring output voltage V_{OUT} is n or (n−1) (similarly for (n−2) or fewer). As a result, the burden of manufacturing and inventory management is reduced, and various applications may be accommodated with a common part (2).

A reference method may be conceived where a power control device capable of generating output voltages for up to n channels is prepared, and the terminal group of unused channels is simply left open. However, with this reference method, abnormal response operations are executed because the output voltage for unused channels is determined to be abnormal. For example, in the reference method, as a result of an error signal being output from the power control device to a higher-level system, the higher-level system would determine that some abnormality has occurred in the power control device. According to the power control device 2 of this embodiment, such inconveniences do not occur.

### Third Example

The third example will be described. In the power supply device 1A of FIG. 8, a case may occur where the output node OUT[1] or switch terminal SW[1] is short-circuited to the input terminal VS[1] or power terminal IN continuously from before time t_{A1} (hereinafter referred to as a startup short-circuit case). In the startup short-circuit case, the determination signals X[1] and Y[1] at time t_{A4} satisfy “(X[1],Y[1])=(1,1)”. In the power supply device 1A, in the case where the determination signals X[1] and Y[1] at time t_{A4} satisfy “(X[1],Y[1])=(1,1)”, the controller 20 may maintain the value of the enable signal EN[1] at “0” thereafter to stop the switching drive by the control drive circuit 11[1], and it may perform the same abnormal response operation as when it determines that a high side abnormality has occurred in the output voltage V_{OUT}[1].

Also in the power supply device 1A of FIG. 8, a case may occur where the output node OUT[1] or switch terminal SW[1] is short-circuited to ground continuously from before time t_{A1} (hereinafter referred to as a startup ground-fault case). In the startup ground-fault case, the determination signals X[1] and Y[1] at time t_{A4} satisfy “(X[1],Y[1])=(0,0)”. Thus, in the startup ground-fault case, switching drive by the control drive circuit 11[1] is initiated, but after the start of switching drive, as a result of the low side abnormality being detected through the execution of voltage monitoring operation, the switching drive is safely stopped in the abnormal response operation.

It is noted that in the power supply device 1A of FIG. 8, since the switch terminal SW[1] and the feedback terminal VO[1] are DC short-circuited through the output coil L[1], the determination signals X[1] and Y[1] at time t_{A4} does not satisfy “(X[1],Y[1])=(1,0)” or “(X[1],Y[1])=(0,1)”.

### Fourth Example

The fourth example will be described. The controller 20 according to the fourth example controls whether to have the control drive circuit 11[1] perform switching drive thereafter based only on the determination signal X[1] among the determination signals X[1] and Y[1]. In the fourth example, the generation and output of the determination signal Y[1] by the voltage monitoring circuit 12[1] may be omitted.

Thus, the controller 20 according to the fourth example controls whether to have the control drive circuit 11[1] perform switching drive thereafter based on the voltage V_{SW}[1] of the switch terminal SW[1] at the determination timing when switching drive by the control drive circuit 11[1] is not executed. Specifically, the controller 20 according to the fourth example, regarding the voltage V_{SW}[1] at the determination timing when switching drive by the control drive circuit 11[1] is not executed, decides to have the control drive circuit 11[1] perform switching drive thereafter in case CS4a where “V_{SW}[1]<V_{THSW}” is satisfied, and decides not to have the control drive circuit 11[1] perform switching drive thereafter (decides to inhibit switching drive by the control drive circuit 11[1]) in case CS4b where “V_{SW}[1]=V_{THSW}” is satisfied. In case CS4a, after the start of switching drive by the control drive circuit 11[1], voltage monitoring operation by the voltage monitoring circuit 12[1] is executed, and thus abnormal response operation based on signals OVD[1] and LVD[1] may be executed. In case CS4b, since switching drive by the control drive circuit 11[1] is not executed, voltage monitoring operation by the voltage monitoring circuit 12[1] is not executed, and thus abnormal response operation based on signals OVD[1] and LVD[1] is also not executed.

In the case where the power supply device 1 is the power supply device 1A of FIG. 8, time t_{A3} corresponds to the determination timing, and the voltage V_{SW}[1] at the determination timing satisfies “V_{SW}[1]<V_{THSW}”. That is, in the fourth example, the case where the power supply device 1 is the power supply device 1A corresponds to case CS4a. The timing chart of the power control device 2 in case CS4a is similar to that of FIG. 9, and in case CS4a, operations similar to the first example are performed in the power supply device 1A and the power control device 2. However, operations related to the determination signal Y[1] shown in the first example are ignored in the fourth example. Alternatively, it may be understood that the operation of the first example is realized by considering that “Y[1]=0” is always satisfied in case CS4a.

In the case where the power supply device 1 is the power supply device 1B of FIG. 10, time t_{B3} corresponds to the determination timing, and the voltage V_{SW}[1] at the determination timing satisfies “V_{SW}[1]≥V_{THSW}”. That is, in the fourth example, the case where the power supply device 1 is the power supply device 1B corresponds to case CS4b. The timing chart of the power control device 2 in case CS4b is similar to that of FIG. 11, and in case CS4b, operations similar to the second example are performed in the power supply device 1B and the power control device 2. However, operations related to the determination signal Y[1] shown in the second example are ignored in the fourth example. Alternatively, it may be understood that the operation of the second example is realized by considering that “Y[1]=0” is always satisfied in case CS4b.

### Fifth Example

The fifth example will be described. The controller 20 according to the fifth example controls whether to have the control drive circuit 11[1] perform switching drive thereafter based only on the determination signal Y[1] among the determination signals X[1] and Y[1]. In the fifth example, the generation and output of the determination signal X[1] by the determination circuit 13[1] may be omitted.

Thus, the controller 20 according to the fifth example controls whether to have the control drive circuit 11[1] perform switching drive thereafter based on the voltage V_{FB}[1] of the feedback terminal VO[1] at the determination timing when switching drive by the control drive circuit 11[1] is not executed. Specifically, the controller 20 according to the fifth example, regarding the voltage V_{FB}[1] at the determination timing when switching drive by the control drive circuit 11[1] is not executed, decides to have the control drive circuit 11[1] perform switching drive thereafter in case CS5a where “V_{FB}[1]<V_{THFB}” is satisfied, and decides not to have the control drive circuit 11[1] perform switching drive thereafter (decides to inhibit switching drive by the control drive circuit 11[1]) in case CS5b where “V_{FB}[1]≥V_{THFB}” is satisfied. In case CS5a, after the start of switching drive by the control drive circuit 11[1], voltage monitoring operation by the voltage monitoring circuit 12[1] is executed, and thus abnormal response operation based on signals OVD[1] and LVD[1] may be executed. In case CS5b, since switching drive by the control drive circuit 11[1] is not executed, voltage monitoring operation by the voltage monitoring circuit 12[1] is not executed, and thus abnormal response operation based on signals OVD[1] and LVD[1] is also not executed.

In the case where the power supply device 1 is the power supply device 1A of FIG. 8, time t_{A3} corresponds to the determination timing, and the voltage V_{FB}[1] at the determination timing satisfies “V_{FB}[1]<V_{THFB}”. That is, in the fifth example, the case where the power supply device 1 is the power supply device 1A corresponds to case CS5a. The timing chart of the power control device 2 in case CS5a is similar to that of FIG. 9, and in case CS5a, operations similar to the first example are performed in the power supply device 1A and the power control device 2. However, operations related to the determination signal X[1] shown in the first example are ignored in the fifth example. Alternatively, it may be understood that the operation of the first example is realized by considering that “X[1]=0” is always satisfied in case CS5a.

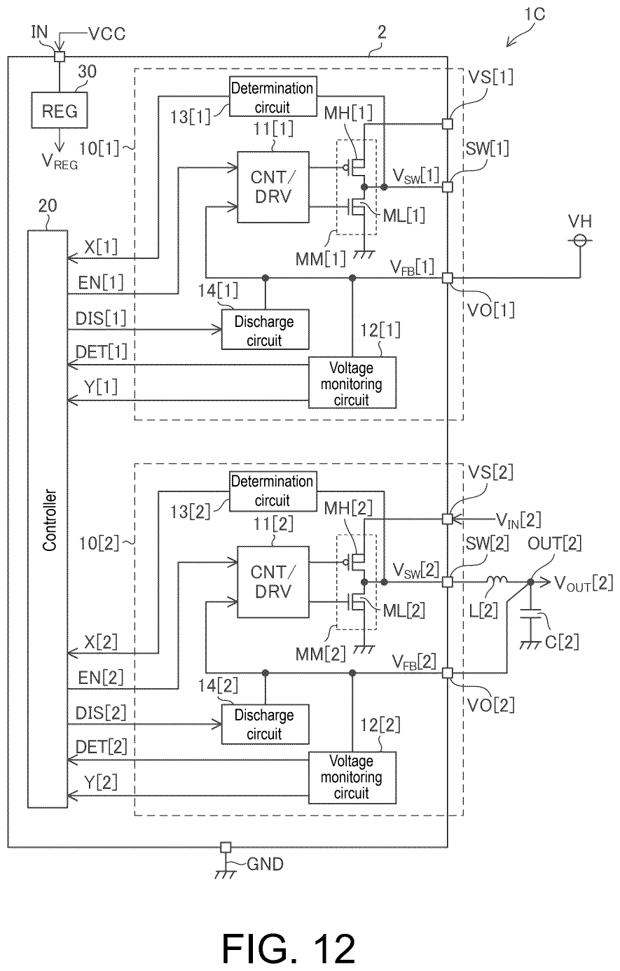

In the fifth example, when the first channel is not used, the power supply device 1C of FIG. 12 is formed as the power supply device 1. Based on the power supply device 1B of FIG. 10, the power supply device 1C of FIG. 12 is obtained by replacing the connection destination of the application end of voltage VH from the switch terminal SW[1] to the feedback terminal VO[1]. Except for this replacement, the power supply device 1C has a similar configuration to the power supply device 1B. The voltage VH is equal to or higher than the threshold voltage V_{THFB} mentioned above, and it is preferable that it is sufficiently higher than the threshold voltage V_{THFB}. Typically, the voltage VH may be the power supply voltage VCC.

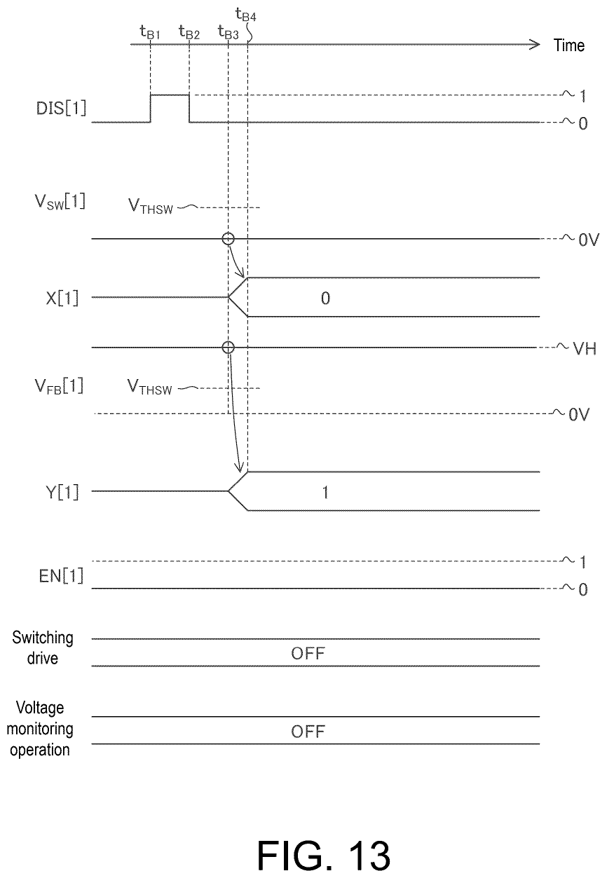

In the case where the power supply device 1 is the power supply device 1C, time t_{B3} corresponds to the determination timing, and the voltage V_{FB}[1] at the determination timing satisfies “V_{FB}[1]≥V_{THFB}”. That is, in the fifth example, the case where the power supply device 1 is the power supply device 1C corresponds to case CS5b. The timing chart of the power control device 2 in case CS5b is shown in FIG. 13, and in case CS5b, operations similar to the second example are performed in the power supply device 1C and the power control device 2. However, operations related to the determination signal X[1] shown in the second example are ignored in the fifth example. Alternatively, it may be understood that the operation of the second example is realized by considering that “X[1]=0” is always satisfied in case CS5b. FIG. 13 is a modification of a part of FIG. 11. In the timing chart of FIG. 13, “Y[1]=1” at time t_{B4} and thereafter because “V_{FB}[1]≥V_{THFB}” is always satisfied. In the power supply device 1C of FIG. 12, when the discharge operation is executed for the first channel, current flows from the application end of voltage VH through the discharge circuit 14[1], but no problem occurs because a resistor (14[1]; see FIG. 6) for limiting the current is provided in the discharge circuit 14[1].

### Sixth Example

The sixth example will be described

In the case where a step-down switching regulator is configured in the i-th channel, the switching drive may be started from a state where the voltage of the output node OUT[i] is 0V by the discharge operation of the discharge circuit 14[i]. However, in the technology according to the disclosure, it is also possible to omit the discharge circuit 14[i].

The transistor ML[i] in the i-th channel is a rectifier element. A diode rectification method may be adopted in the step-down switching regulator included in the power supply device 1. In this case, instead of the transistor ML[i], a rectifying diode having an anode connected to ground and a cathode connected to the switch terminal SW[i] is provided in the output stage circuit MM[i] as the rectifier element. In this case, only the transistor MH[i] is turned on and off in the switching drive of the output stage circuit MM[i]. In any case, when a step-down switching regulator is configured in the i-th channel, the output voltage V_{OUT}[i] is generated based on the current flowing through the output coil L[i] by switching the transistor MH[i] between on and off in the switching drive of the output stage circuit MM[i].

Regarding any signal or voltage, without compromising the above principles, the relationship between their high level and low level may be reversed from what was described above.

The types of channels of the FETs (field effect transistors) shown in the above embodiments are exemplary. Without compromising the above principles, the channel type of any FET may be changed between P channel type and N channel type.

As long as no inconvenience occurs, any transistor mentioned above may be of any type. For example, any transistor described above as a MOSFET may be replaced with a junction FET, IGBT (insulated gate bipolar transistor), or bipolar transistor as long as no inconvenience occurs. Any transistor includes a first electrode, a second electrode, and a control electrode. In a FET, one of the first and second electrodes is a drain and the other is a source, and the control electrode is a gate. In an IGBT, one of the first and second electrodes is a collector and the other is an emitter, and the control electrode is a gate. In a bipolar transistor that does not belong to IGBT, one of the first and second electrodes is a collector and the other is an emitter, and the control electrode is a base.

The embodiments of the disclosure may be appropriately modified in various ways within the scope of the technical concept shown in the claims. The above embodiments are merely examples of the embodiments of the disclosure, and the meanings of the terms of the disclosure or each component are not limited to those described in the above embodiments. The specific numerical values shown in the above description are merely examples, and they may naturally be changed to various numerical values.

### NOTE

A note will be provided regarding the disclosure for which specific configuration examples are shown in the above-described embodiments.

A power control device (2) according to one aspect of the disclosure includes: an input terminal (VS[1]); a switch terminal (SW[1]); an output stage circuit (MM[1]), including an output transistor (MH[1]) provided between the input terminal and the switch terminal, and a rectifier element (ML[1]) provided between the switch terminal and ground; a control drive circuit (11[1]), in a case where an input voltage (V_{IN}[1]) is supplied to the input terminal, an output coil (L[1]) is provided between the switch terminal and an output node (OUT[1]), and an output capacitor (C[1]) is provided between the output node and ground, configured to be capable of executing switching drive of the output stage circuit corresponding to a feedback voltage (V_{FB}[1]) and to generate an output voltage (V_{OUT}[1]) based on the input voltage at the output node by the switching drive; a feedback terminal (VO[1]), in a case where the input voltage is supplied to the input terminal, the output coil is provided between the switch terminal and the output node, and the output capacitor is provided between the output node and ground, configured to receive the feedback voltage corresponding to the output voltage; and a controller (20), configured to control whether or not to have the control drive circuit perform the switching drive based on voltages (V_{SW}[1], V_{FB}[1]) of the switch terminal and the feedback terminal at a determination timing when the switching drive is not executed (first configuration).

Accordingly, by defining the states of the switch terminal and the feedback terminal, the execution or non-execution of the switching drive may be realized as desired.

With respect to the power control device according to the first configuration, at the determination timing, current through the switch terminal is blocked, a resistor (12a, 12b) is provided between the feedback terminal and ground, and the controller is configured to: in a first case where a voltage of the switch terminal at the determination timing is less than a first threshold voltage (V_{THSW}) and a voltage of the feedback terminal at the determination timing is less than a second threshold voltage (V_{THFB}), have the control drive circuit perform the switching drive after the determination timing, and in a second case where a voltage of the switch terminal at the determination timing is equal to or greater than the first threshold voltage and a voltage of the feedback terminal at the determination timing is less than the second threshold voltage, inhibit the switching drive by the control drive circuit after the determination timing (second configuration).

Accordingly, by defining the states of the switch terminal and the feedback terminal, the execution or non-execution of the switching drive may be realized as desired.

The power control device according to the second configuration includes a voltage monitoring circuit (12[1]) configured to perform a voltage monitoring operation for detecting an abnormality of the output voltage based on a voltage of the feedback terminal after starting the switching drive, in which in the second case, the voltage monitoring operation by the voltage monitoring circuit is inhibited (third configuration).

In the power control device according to the third configuration, the voltage monitoring circuit monitors whether a voltage of the feedback terminal falls within a predetermined normal voltage range in the voltage monitoring operation and outputs a monitoring result (DET[1]) to the controller, and the controller, in the first case, executes a predetermined abnormal response operation when a voltage of the feedback terminal deviates from the normal voltage range, and in the second case, inhibits execution of the abnormal response operation based on a voltage of the feedback terminal (fourth configuration).

It is not appropriate for the voltage monitoring operation to be executed and the abnormal response operation to be executed in the second case where switching drive is not executed. By configuring as described above, inappropriate abnormal response operations are suppressed.

With respect to the power control device according to any one of the second to fourth configurations, in the first case, a step-down switching regulator is formed by the output stage circuit, the control drive circuit, the output coil, and the output capacitor, and in the second case, the switch terminal is connected to an application end of a voltage (VH) equal to or greater than the first threshold voltage (fifth configuration).

The power control device according to the fifth configuration may be configured to control an operation of a power supply device (1) having a plurality of channels of regulators, and in the first case, the step-down switching regulator is formed as one of the plurality of channels of regulators (sixth configuration).

With respect to the power control device according to the sixth configuration, in the first case, in each of n channels of regulators including the step-down switching regulator, power conversion that converts a direct current voltage to another direct current voltage is executed, and in the power conversion by the step-down switching regulator, the output voltage is generated from the input voltage, where n represents an integer equal to or greater than 2, and in the second case, the step-down switching regulator is not formed, and the power conversion is executed in each of one or more regulators fewer than the n channels (seventh configuration).

This enables the use or non-use of a certain channel to be realized as desired.

In the power control device according to any one of the first to seventh configurations, the rectifier element is a synchronous rectification transistor, and at the determination timing, the output transistor and the synchronous rectification transistor are maintained in an off state (eighth configuration).

A power control device according to another aspect of the disclosure is a power control device (2) including: an input terminal (VS[1]); a switch terminal (SW[1]); an output stage circuit (MM[1]), including an output transistor (MH[1]) provided between the input terminal and the switch terminal, and a rectifier element (ML[1]) provided between the switch terminal and ground; a control drive circuit (11[1]), in a case where an input voltage (V_{IN}[1]) is supplied to the input terminal, an output coil (L[1]) is provided between the switch terminal and an output node (OUT[1]), and an output capacitor (C[1]) is provided between the output node and ground, configured to be capable of executing switching drive of the output stage circuit corresponding to a feedback voltage (V_{FB}[1]) and to generate an output voltage (V_{OUT}[1]) based on the input voltage at the output node by the switching drive; a feedback terminal (VO[1]), in a case where the input voltage is supplied to the input terminal, the output coil is provided between the switch terminal and the output node, and the output capacitor is provided between the output node and ground, configured to receive the feedback voltage corresponding to the output voltage; and a controller (20), configured to control whether or not to have the control drive circuit perform the switching drive based on a voltage of the switch terminal (V_{SW}[1]) or a voltage (V_{FB}[1]) of the feedback terminal at a determination timing when the switching drive is not executed (ninth configuration).

Accordingly, by defining the states of the switch terminal or the feedback terminal, the execution or non-execution of the switching drive may be realized as desired.

With respect to the power control device according to the ninth configuration, at the determination timing, current through the switch terminal is blocked, a resistor (12a, 12b) is provided between the feedback terminal and ground, and the controller is configured to: in a first case where a voltage of the switch terminal or a voltage of the feedback terminal at the determination timing is less than a threshold voltage (V_{THSW}, V_{THFB}), have the control drive circuit perform the switching drive after the determination timing, and in a second case where a voltage of the switch terminal or a voltage of the feedback terminal at the determination timing is equal to or greater than the threshold voltage, inhibit the switching drive by the control drive circuit after the determination timing (tenth configuration).

Accordingly, by defining the states of the switch terminal or the feedback terminal, the execution or non-execution of the switching drive may be realized as desired.

The power control device according to the tenth configuration includes a voltage monitoring circuit (12[1]) configured to perform a voltage monitoring operation for detecting an abnormality of the output voltage based on a voltage of the feedback terminal after starting the switching drive, in which in the second case, the voltage monitoring operation by the voltage monitoring circuit is inhibited (eleventh configuration).

In the power control device according to the eleventh configuration, the voltage monitoring circuit monitors whether a voltage of the feedback terminal falls within a predetermined normal voltage range in the voltage monitoring operation and outputs a monitoring result (DET[1]) to the controller, and the controller, in the first case, executes a predetermined abnormal response operation when a voltage of the feedback terminal deviates from the normal voltage range, and in the second case, inhibits execution of the abnormal response operation based on a voltage of the feedback terminal (twelfth configuration).

It is not appropriate for the voltage monitoring operation to be executed and the abnormal response operation to be executed in the second case where switching drive is not executed. By configuring as described above, inappropriate abnormal response operations are suppressed.

With respect to the power control device according to any one of the tenth to twelfth configurations, in the first case, a step-down switching regulator is formed by the output stage circuit, the control drive circuit, the output coil, and the output capacitor, and in a case where whether to have the control drive circuit perform the switching drive is controlled based on a voltage of the switch terminal at the determination timing, the switch terminal in the second case is connected to an application end of a voltage (VH) equal to or greater than the threshold voltage, and in a case where whether to have the control drive circuit perform the switching drive is controlled based on a voltage of the feedback terminal at the determination timing, the feedback terminal in the second case is connected to the application end of a voltage (VH) equal to or greater than the threshold voltage (thirteenth configuration).

The power control device according to the thirteenth configuration may be configured to control an operation of a power supply device having a plurality of channels of regulators, and in the first case, the step-down switching regulator is formed as one of the plurality of channels of regulators (fourteenth configuration).

With respect to the power control device according to the fourteenth configuration, in the first case, in each of n channels of regulators including the step-down switching regulator, power conversion that converts a direct current voltage to another direct current voltage is executed, and in the power conversion by the step-down switching regulator, the output voltage is generated from the input voltage, where n represents an integer equal to or greater than 2, and in the second case, the step-down switching regulator is not formed, and the power conversion is executed in each of one or more regulators fewer than the n channels (fifteenth configuration).

This enables the use or non-use of a certain channel to be realized as desired.

In the power control device according to any one of the ninth to fifteenth configurations, the rectifier element is a synchronous rectification transistor, and at the determination timing, the output transistor and the synchronous rectification transistor are maintained in an off state (sixteenth configuration).

What is claimed is:

1. A power control device, comprising:
an input terminal;
a switch terminal;
an output stage circuit, comprising an output transistor provided between the input terminal and the switch terminal, and a rectifier element provided between the switch terminal and ground;
a control drive circuit, in a case where an input voltage is supplied to the input terminal, an output coil is provided between the switch terminal and an output node, and an output capacitor is provided between the output node and ground, configured to be capable of executing switching drive of the output stage circuit corresponding to a feedback voltage and to generate an output voltage based on the input voltage at the output node by the switching drive;
a feedback terminal, in a case where the input voltage is supplied to the input terminal, the output coil is provided between the switch terminal and the output node, and the output capacitor is provided between the output node and ground, configured to receive the feedback voltage corresponding to the output voltage; and
a controller, configured to control whether or not to have the control drive circuit perform the switching drive based on voltages of the switch terminal and the feedback terminal at a determination timing when the switching drive is not executed.

2. The power control device according to claim 1, wherein at the determination timing, current through the switch terminal is blocked,
a resistor is provided between the feedback terminal and ground, and
the controller is configured to:
in a first case where a voltage of the switch terminal at the determination timing is less than a first threshold voltage and a voltage of the feedback terminal at the determination timing is less than a second threshold voltage, have the control drive circuit perform the switching drive after the determination timing, and
in a second case where a voltage of the switch terminal at the determination timing is equal to or greater than the first threshold voltage and a voltage of the feedback terminal at the determination timing is less than the second threshold voltage, inhibit the switching drive by the control drive circuit after the determination timing.

3. The power control device according to claim 2, comprising a voltage monitoring circuit configured to perform a voltage monitoring operation for detecting an abnormality of the output voltage based on a voltage of the feedback terminal after starting the switching drive,
wherein in the second case, the voltage monitoring operation by the voltage monitoring circuit is inhibited.

4. The power control device according to claim 3, wherein the voltage monitoring circuit monitors whether a voltage of the feedback terminal falls within a predetermined normal voltage range in the voltage monitoring operation and outputs a monitoring result to the controller, and
the controller, in the first case, executes a predetermined abnormal response operation when a voltage of the feedback terminal deviates from the normal voltage range, and in the second case, inhibits execution of the abnormal response operation based on a voltage of the feedback terminal.

5. The power control device according to claim 2, wherein in the first case, a step-down switching regulator is formed by the output stage circuit, the control drive circuit, the output coil, and the output capacitor, and
in the second case, the switch terminal is connected to an application end of a voltage equal to or greater than the first threshold voltage.

6. The power control device according to claim 5, wherein the power control device is configured to control an operation of a power supply device having a plurality of channels of regulators, and
in the first case, the step-down switching regulator is formed as one of the plurality of channels of regulators.

7. The power control device according to claim 6, wherein in the first case, in each of n channels of regulators comprising the step-down switching regulator, power conversion that converts a direct current voltage to another direct current voltage is executed, and in the power conversion by the step-down switching regulator, the output voltage is generated from the input voltage, where n represents an integer equal to or greater than 2, and
in the second case, the step-down switching regulator is not formed, and the power conversion is executed in each of one or more regulators fewer than the n channels.

8. The power control device according to claim 1, wherein the rectifier element is a synchronous rectification transistor, and at the determination timing, the output transistor and the synchronous rectification transistor are maintained in an off state.

9. A power control device, comprising:
an input terminal;
a switch terminal;
an output stage circuit, comprising an output transistor provided between the input terminal and the switch terminal, and a rectifier element provided between the switch terminal and ground;
a control drive circuit, in a case where an input voltage is supplied to the input terminal, an output coil is provided between the switch terminal and an output node, and an output capacitor is provided between the output node and ground, configured to be capable of executing switching drive of the output stage circuit corresponding to a feedback voltage and to generate an output voltage based on the input voltage at the output node by the switching drive;
a feedback terminal, in a case where the input voltage is supplied to the input terminal, the output coil is provided between the switch terminal and the output node, and the output capacitor is provided between the output node and ground, configured to receive the feedback voltage corresponding to the output voltage; and
a controller, configured to control whether or not to have the control drive circuit perform the switching drive based on a voltage of the switch terminal or a voltage of the feedback terminal at a determination timing when the switching drive is not executed.

10. The power control device according to claim 9, wherein at the determination timing, current through the switch terminal is blocked,
a resistor is provided between the feedback terminal and ground, and
the controller is configured to:
in a first case where a voltage of the switch terminal or a voltage of the feedback terminal at the determination timing is less than a threshold voltage, have the control drive circuit perform the switching drive after the determination timing, and
in a second case where a voltage of the switch terminal or a voltage of the feedback terminal at the determination timing is equal to or greater than the threshold voltage, inhibit the switching drive by the control drive circuit after the determination timing.

11. The power control device according to claim 10, comprising a voltage monitoring circuit configured to perform a voltage monitoring operation for detecting an abnormality of the output voltage based on a voltage of the feedback terminal after starting the switching drive,
wherein in the second case, the voltage monitoring operation by the voltage monitoring circuit is inhibited.

12. The power control device according to claim 11, wherein the voltage monitoring circuit monitors whether a voltage of the feedback terminal falls within a predetermined normal voltage range in the voltage monitoring operation and outputs a monitoring result to the controller, and
the controller, in the first case, executes a predetermined abnormal response operation when a voltage of the feedback terminal deviates from the normal voltage range, and in the second case, inhibits execution of the abnormal response operation based on a voltage of the feedback terminal.

13. The power control device according to claim 10, wherein in the first case, a step-down switching regulator is formed by the output stage circuit, the control drive circuit, the output coil, and the output capacitor, and
in a case where whether to have the control drive circuit perform the switching drive is controlled based on a voltage of the switch terminal at the determination timing, the switch terminal in the second case is connected to an application end of a voltage equal to or greater than the threshold voltage, and
in a case where whether to have the control drive circuit perform the switching drive is controlled based on a voltage of the feedback terminal at the determination timing, the feedback terminal in the second case is connected to the application end of a voltage equal to or greater than the threshold voltage.

14. The power control device according to claim 13, wherein the power control device is configured to control an operation of a power supply device having a plurality of channels of regulators, and
in the first case, the step-down switching regulator is formed as one of the plurality of channels of regulators.

15. The power control device according to claim 14, wherein in the first case, in each of n channels of regulators comprising the step-down switching regulator, power conversion that converts a direct current voltage to another direct current voltage is executed, and in the power conversion by the step-down switching regulator, the output voltage is generated from the input voltage, where n represents an integer equal to or greater than 2, and
in the second case, the step-down switching regulator is not formed, and the power conversion is executed in each of one or more regulators fewer than the n channels.

16. The power control device according to claim 9, wherein the rectifier element is a synchronous rectification transistor, and at the determination timing, the output transistor and the synchronous rectification transistor are maintained in an off state.
